(19) United States
(12) Patent Application Publication
(10) Pub. No.: US 2011/0222872 A1
(43) Pub. Date: Sep. 15, 2011

(54) IMAGE FORMING APPARATUS

(75) Inventors: Tomoki Minamikawa, Osaka (JP); Motoyuki Itoyama, Osaka (JP); Hideji Saikoh, Osaka (JP); Kazuma Hinoue, Osaka (JP)

(73) Assignee: SHARP KABUSHIKI KAISHA, Osaka (JP)

(21) Appl. No.: 13/039,798

(22) Filed: Mar. 3, 2011

(30) Foreign Application Priority Data
Mar. 15, 2010 (JP) 2010-057946
Jun. 25, 2010 (JP) 2010-144766

(51) Int. Cl. G03G 15/08

(52) U.S. Cl. 399/27; 399/258; 399/44

(57) ABSTRACT

An image forming apparatus includes: a developing device; a toner supply device that supplies toner to the developing device; and a toner supply detecting sensor that detects whether toner is supplied into the developing device; and a toner empty determination controller for determining that the toner inside the toner supply device is used up. Toner empty determination controller, based on the output result from the toner supply detecting sensor, modifies the toner empty determining threshold, based on which toner empty is determined.

This Nonprovisional application claims priority under 35 U.S.C. §119(a) on Patent Application No. 2010-57946 filed in Japan on 15 Mar. 2010 and Patent Application No. 2010-144766 filed in Japan on 25 Jun. 2010, the entire contents of which are hereby incorporated by reference.

### BACKGROUND OF THE INVENTION

(1) Field of the Invention

The present invention relates to an image forming apparatus, in particular relating to an image forming apparatus such as an electrostatic copier, laser printer, facsimile machine or the like that includes a developing device using a dual-component developer containing a toner and a magnetic carrier and forms images using toner based on electrophotography.

(2) Description of the Prior Art

Conventionally, image forming apparatuses based on electrophotography such as copiers, printers, facsimile machines and the like have been known. The image forming apparatus using electrophotography is constructed so as to form an image by forming an electrostatic latent image on the surface of a photoreceptor, e.g., photoreceptor drum, supplying toner to the photoreceptor drum from a developing device to develop the electrostatic latent image, transferring the toner image formed on photoreceptor drum by development to a sheet of paper etc., and fixing the toner image onto the sheet by means of a fixing device.

Recently, in the image forming apparatuses supporting full-color and/or high-quality images, a dual-component developer (which will be referred to hereinbelow simply as “developer”), which presents excellent charge performance stability, is often used.

This developer consists of a toner and a carrier, which are agitated in the developing device and frictionally rubbed with each other to thereby produce appropriately electrified toner.

The electrified toner in the developing device is supplied to a dual-component developer supporting member, e.g., the surface of a developing roller. The toner thus supplied to the developing roller is moved by electrostatic attraction to the electrostatic latent image formed on the photoreceptor drum. Hereby, a toner image based on the electrostatic latent image is formed on the photoreceptor drum.

Further, recently, image forming apparatuses are demanded to be made compact and operate at high speeds, hence it has become necessary to electrify the developer quickly and sufficiently and also convey the developer quickly and smoothly.

For this purpose, in order to disperse supplied toner promptly into the developer and provide the toner with an appropriate amount of charge, a circulating type developing device has been adopted in some image forming apparatuses.

This circulating type developing device includes: a developer conveying passage in which the developer is circulatively conveyed; a screw auger (developer conveying member) for conveying the developer while agitating the developer in the developer conveying passage; a toner supply port for leading toner from a toner container into the developer conveying passage; and a toner concentration detecting sensor for detecting the toner concentration in the developer. In this arrangement, when the toner concentration in the developer is lower than a predetermined level, a toner supply command is given to the toner cartridge so that toner is supplied to the developer conveying passage and the supplied toner is conveyed whilst being agitated (see Patent Document 1).

In order to keep toner concentration stable by toner supply, a configuration has been proposed with which high-precision toner concentration detection is made possible from the state in which the toner to be supplied is left in the toner tank to the toner empty state, by switching the level of the input signal to be input to the toner concentration detecting sensor, based on the output signal from the toner concentration detecting sensor for detecting toner concentration in the developer (see Patent Document 2).
Patent Document 1:
   Japanese Patent Application Laid-open 2006-106194
Patent Document 2:
   Japanese Patent Application Laid-open 2002-72659

In the aforementioned circulating type developing device using the dual-component developer, if toner to be supplied from the toner cartridge to the developing device is used up, the toner concentration in the developer gradually decreases. Since the occurrence of carrier phenomena (carrier adherence) to the photoreceptor drum increases with the decrease of toner concentration, it is necessary to perform toner empty detection.

Toner empty detection is to determine (detect) the occurrence of a toner empty state when, for example, the toner concentration of the developer in the developing device, detected by the toner supply detecting sensor does not increase even after a toner supply command was given to the toner cartridge.

However, in the case where no toner is supplied even after a toner supply command was given to the toner cartridge because of toner empty in the toner cartridge, if the toner concentration detecting sensor is located away from the toner supply port through which toner is supplied, detection of toner empty is delayed because the fall of toner concentration detected by the toner concentration detecting sensor is sluggish. As a result, there occurs the problem that the occurrence of carrier adherence becomes more frequent.

### SUMMARY OF THE INVENTION

The present invention has been devised in view of the above problem, it is therefore an object of the present invention to provide an image forming apparatus that can detect toner empty, i.e., an empty state of toner to be supplied to the developing device, at an exact timing with precision.

The image forming apparatus according to the present invention for solving the above problem is configured as follows:

In accordance with the first aspect of the present invention, an image forming apparatus includes: a developing device; a toner supply device; a toner supply detecting sensor; and, a toner empty determination controller, and is characterized in that the developing device comprises: a developer container for storing a developer including a toner and a magnetic carrier; a developer conveying structure disposed inside the developer container for circulatively conveying the developer whilst agitating; a developing roller for supplying the toner included in the developer to a photoreceptor drum; and, a toner supply port that leads supplied toner into the developer container, the toner supply device supplies the toner into the developing device, the toner supply detecting sensor detects whether the toner has been supplied into the developer container, the toner empty determination controller instructs the toner supply device to supply toner to the developing device when the toner concentration of the developer in the developing device has become lower than a predetermined level, the toner empty determination controller determines that the toner in the toner supply device is used up when no toner supply is detected by the toner supply detecting sensor after the instruction of toner supply by the controller, and, the toner empty determination controller, based on the output result from the toner supply detecting sensor, corrects the toner empty determining threshold based on which toner empty is determined.

The second aspect of the present invention is characterized in that the toner empty determination controller performs the correction, based on, at least, any one of, the average of the differences between the detected values output from the toner supply detecting sensor before and after toner supply at the time of supplying toner, the control voltage correction result of the toner supply detecting sensor at the time of image quality control, and the deviation of the output value of the toner supply detecting sensor, from the reference value.

The third aspect of the present invention is characterized in that the toner empty determination controller performs the correction, based on, at least, any one of, the temperature and humidity environment (temperature/humidity information) under which the image forming apparatus is used, the mean coverage rate information of printout operation, and the life information of the developer.

The fourth aspect of the present invention is characterized in that the toner empty determination controller performs the correction, based on the amount of toner remaining in a replaceable toner storing container.

The fifth aspect of the present invention is characterized in that the toner supply detecting sensor is disposed near the toner supply port in the developer container.

The sixth aspect of the present invention is characterized in that the toner supply detecting sensor detects the magnetic permeability of the developer in the developer container.

The seventh aspect of the present invention is characterized in that the developing device includes: a first conveying passage and a second conveying passage that are sectioned by a partitioning wall and arranged to communicate with each other at both ends of the partitioning wall; and, a first conveying member and a second conveying member that are arranged as the developer conveying structure in the first conveying passage and second conveying passage, respectively, agitate and circulatively convey the developer in the first conveying passage and in the second conveying passage, in opposite directions to each other, the developing device supplies the developer inside the second conveying passage to the photoreceptor drum by means of the developing roller, the toner supply port is disposed over the first conveying passage, and, the toner supply detecting sensor is disposed at the bottom of the first conveying passage under the toner supply port.

The eighth aspect of the present invention is characterized in that the first conveying member is a screw auger having a rotary shaft and a helical blade, and the helical blade is formed so that the inclined angle relative to the axial direction of the rotary shaft (the angle formed between the rotary shaft and the outer peripheral edge of the helical blade when the rotary shaft is viewed along the axis) is specified to fall within the range of 30 degrees to 60 degrees.

The ninth aspect of the present invention resides in the image forming apparatus further including a dot counter for counting dots of data corresponding to image data to be transmitted to the exposure device (e.g., a laser scanner unit) for forming an electrostatic latent image on the photoreceptor drum surface, wherein the toner empty determination controller instructs the toner supply device to supply toner to the developing device based on the count of the dots of data from the dot counter.

For example, when the number of dots of data counted by the dot counter is small, the toner empty determination controller may instruct the toner supply device to supply a small amount of toner to the developing device. When a large number of dots of data are counted, the controller may instruct the toner supply device to supply a large amount of toner to the developing device. It is preferable that the amount of toner to be supplied has been specified in advance in relation with the condition of dots of data.

According to the first aspect of the present invention, for example, it is possible to absorb occasional fluctuation of the difference (ΔTCS) between the output values from the toner supply detecting sensor before and after toner supply at the time of supplying toner by the toner supply device, depending on the condition of the developer, it is hence possible to perform detection of toner empty at a more exact timing with a higher precision.

According to the second aspect of the present invention, since it is possible to set (modify) the toner empty determining threshold in accordance with the sensor sensitivity of the toner supply detecting sensor that varies depending on the condition of the developer, it is possible to perform detection of toner empty at a more exact timing with a higher precision.

According to the third aspect of the present invention, since it is possible to set (modify) the toner empty determining threshold in accordance with the sensor sensitivity of the toner supply detecting sensor that varies depending on the condition of the developer, it is possible to perform detection of toner empty at a more exact timing with a higher precision.

According to the fourth aspect of the present invention, it is possible to perform detection of toner empty at a more exact timing with a higher precision.

According to the fifth aspect of the present invention, since the toner supply detecting sensor detects presence or absence of toner supply immediately after giving a toner supply command to the toner supply device, it is possible to detect toner empty at once and hence prevent the occurrence of carrier adherence due to a decrease in toner concentration when toner in the toner supply device is used up.

According to the sixth aspect of the present invention, it is possible to easily detect the effect of toner supply by detecting change in toner concentration.

According to the seventh aspect of the present invention, the effect of toner supply can be detected with precision. Specifically, since the pressure on the developer becomes maximum at the bottom of the first conveying passage, voids are unlikely to form inside the developer. Accordingly it is possible to precisely detect the effect of toner supply with the toner supply detecting sensor.

According to the eighth aspect of the present invention, since the force for agitating the developer in the rotational direction of the first conveying member can be enhanced so that “floating toner”, the phenomenon of the added toner being conveyed floating over the developer, is unlikely to occur, it is possible for the toner supply detecting sensor to precisely detect the effect of toner supply.

According to the ninth aspect of the present invention, since it is possible to perform toner supply in a more exact manner compared to toner concentration control based on the toner concentration detected by the toner concentration detecting sensor, it is possible to perform toner concentration control and detection of toner empty, more precisely.

### BRIEF DESCRIPTION OF THE DRAWINGS

FIG. 1 is an illustrative view showing the overall configuration of an image forming apparatus according to the embodiment of the present invention;

FIG. 2 is a sectional view showing a schematic configuration of a toner supply device that constitutes the image forming apparatus;

FIG. 3 is a sectional view cut along a plane D1-D2 in FIG. 2;

FIG. 4 is a sectional view showing a configuration of a developing device that constitutes the image forming apparatus;

FIG. 5 is a sectional view cut along a plane A1-A2 in FIG. 4;

FIG. 6 is a sectional view cut along a plane B1-B2 in FIG. 4;

FIG. 7 is a sectional view cut along a plane C1-C2 in FIG. 5;

FIG. 8 is a block diagram showing a control system configuration in the image forming apparatus;

FIG. 9 is a graph showing the relationship between a toner supply signal indicating a toner supply from the toner supply device and the output from a toner supply detecting sensor;

FIG. 10 is a graph showing temporal variation of the difference (the first moving average) between the output values from toner supply detecting sensor before and after a toner supply from the toner supply device and corresponding temporal change of the toner empty determining threshold;

FIG. 11 is a table for setting a default value of the toner empty determining threshold for the toner supply detecting sensor of each color in the image forming apparatus;

FIG. 12 is a table for presenting corrective values for correcting the toner empty determining threshold in accordance with change in the sensor sensitivity of the toner supply detecting sensor with the passage of time;

FIG. 13 is a table for presenting corrective values for correcting the toner empty determining threshold in accordance with the amount of correction of the control voltage at the time of image quality control in the image forming apparatus;

FIG. 14 is a table for presenting corrective values for correcting the toner empty determining threshold in accordance with the difference (variation) between the output values of the toner supply detecting sensor before and after a toner supply at the time of supplying toner in the image forming apparatus;

FIG. 15 is a table for presenting of ambient area classes depending on temperature and humidity;

FIG. 16 is a table for presenting corrective values in accordance with the class of the ambient area in which the image forming apparatus is used;

FIG. 17 is a table for presenting corrective values for correcting the toner empty determining threshold in accordance with the record of the mean coverage rate of printout operation in the image forming apparatus;

FIG. 18 is a table for presenting corrective values for correcting the toner empty determining threshold in accordance with the life information of the developer in the image forming apparatus;

FIG. 19 is a table for presenting corrective values for correcting the toner empty determining threshold in accordance with the amount of toner remaining in toner storing container in the image forming apparatus; and,

FIG. 20 is a table for presenting the upper and lower limits of the total corrective value for the toner empty determining threshold for each color in the image forming apparatus.

### DESCRIPTION OF THE PREFERRED EMBODIMENTS

Now, the embodied mode for carrying out the present invention will be described with reference to the drawings.

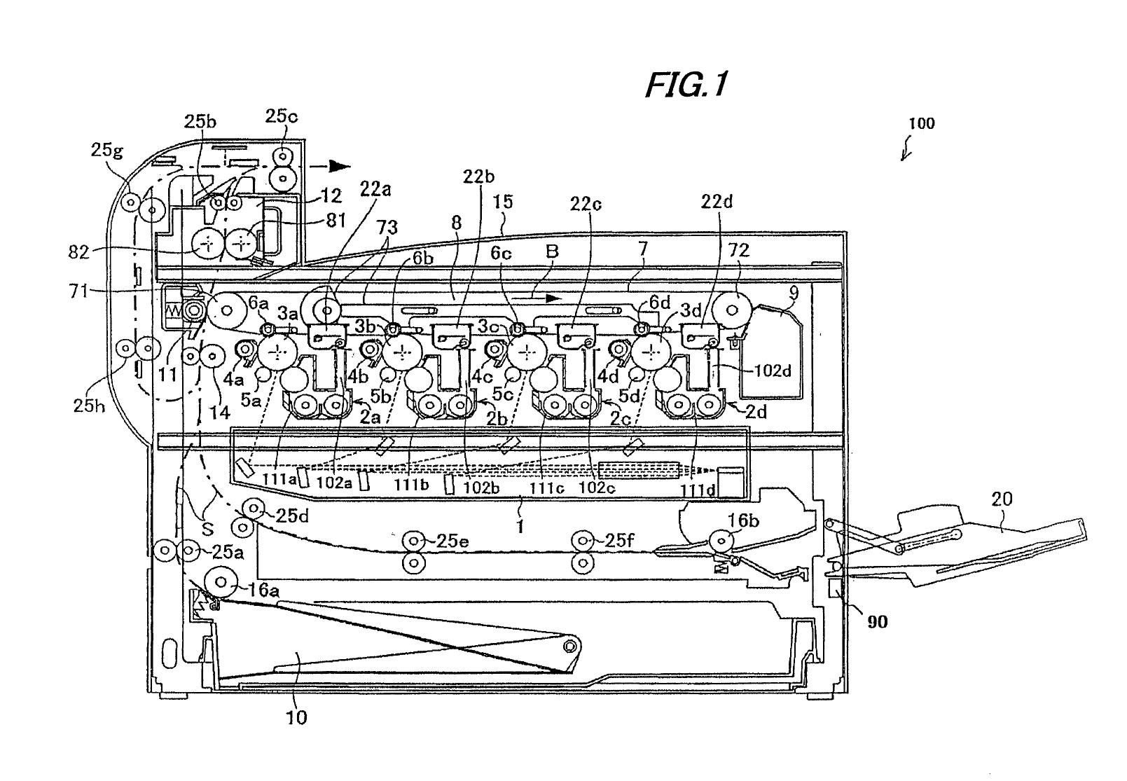

FIG. 1 shows one exemplary embodiment of the present invention, and is an illustrative view showing the overall configuration of an image forming apparatus 100 according to the embodiment of the present invention.

Image forming apparatus 100 of the present embodiment forms an image with toners based on electrophotography, including: as shown in FIG. 1, photoreceptor drums 3a, 3b, 3c and 3d (which may be also called “photoreceptor drums 3” when general mention is made) for forming electrostatic latent images on the surfaces thereof; chargers (charging devices) 5a, 5b, 5c and 5d (which may be also called “chargers 5” when general mention is made) for charging the surfaces of photoreceptor drums 3; an exposure unit (exposure device) 1 for forming electrostatic latent images on the photoreceptor drum 3 surfaces; developing devices 2a, 2b, 2c and 2d (which may be also called “developing devices 2” when general mention is made) for supplying toners to the electrostatic latent images on the photoreceptor drum 3 surfaces to form toner images; toner supply devices 22a, 22b, 22c and 22d (which may be also called “toner supply devices 22” when general mention is made) for supplying toners to developing devices 2; an intermediate transfer belt unit (transfer device) 8 for transferring the toner images from the photoreceptor drum 3 surfaces to a recording medium; and a fixing unit (fixing device) 12 for fixing the toner image to the recording medium.

This image forming apparatus 100 forms a multi-color or monochrome image on a predetermined sheet (recording paper, recording medium) in accordance with image data transmitted from the outside. Here, image forming apparatus 100 may also include a scanner or the like on the top thereof.

To begin with, the overall configuration of image forming apparatus 100 will be described.

As shown in FIG. 1, image forming apparatus 100 separately handles image data of individual color components, i.e., BK (black), C (cyan), M (magenta) and Y (yellow), and forms black, cyan, magenta and yellow images, superimposing these images of different color components to produce a full-color image.

Accordingly, image forming apparatus 100 includes, as shown in FIG. 1, four developing devices 2 (2a, 2b, 2c and 2d), four photoreceptor drums 3 (3a, 3b, 3c and 3d), four chargers 5 (5a, 5b, 5c and 5d) and four cleaner units 4 (4a, 4b, 4c and 4d) to form images of four different colors. In other words, four image forming stations (image forming portions) each including one developing device 2, one photoreceptor drum 3, one charger 5 and one cleaner unit 4 are provided.

Here, the symbols a to d are used so that ‘a’ represents the components for forming black images, ‘b’ the components for forming cyan images, ‘c’ the components for forming magenta images and ‘d’ the components for forming yellow images. Image forming apparatus 100 includes exposure unit 1, fixing unit 12, a sheet conveyor system S and a paper feed tray 10 and a paper output tray 15.

Charger 5 electrifies the photoreceptor drum 3 surface at a predetermined potential.

As charger 5, other than the contact roller-type charger shown in FIG. 1, a contact brush-type charger, a non-contact type discharging type charger and others may be used.

Exposure unit 1 is a laser scanning unit (LSU) including a laser emitter and reflection mirrors as shown in FIG. 1. Other than the laser scanning unit, arrays of light emitting elements such as EL (electroluminescence) and LED writing heads, may be also used as exposure unit 1. Exposure unit 1 illuminates the photoreceptor drums 3 that have been electrified, in accordance with input image data so as to form electrostatic latent images corresponding to the image data on the surfaces of photoreceptor drums 3.

Developing device 2 visualizes (develops) the electrostatic latent image formed on photoreceptor drum 3 with toner of BK, C, M or Y. Arranged over developing devices 2 (2a, 2b, 2c and 2d) are toner transport mechanisms 102 (102a, 102b, 102c and 102d), toner supply devices 22 (22a, 22b, 22c and 22d) and developing vessels (developer containers) 111 (111a, 111b, 111c and 111d).

Toner supply device 22 is arranged on the upper side of developing vessel 111 and stores unused toner (powdery toner). This unused toner is supplied from toner supply device 22 to developing vessel 111 by means of toner transport mechanism 102.

Cleaner unit 4 removes and collects the toner remaining on the photoreceptor drum 3 surface after development and image transfer steps.

Arranged over photoreceptor drums 3 is an intermediate transfer belt unit 8. Intermediate transfer belt unit 8 includes intermediate transfer rollers 6 (6a, 6b, 6c and 6d), an intermediate transfer belt 7, an intermediate transfer belt drive roller 71, an intermediate transfer belt driven roller 72, an intermediate transfer belt tensioning mechanism 73 and an intermediate transfer belt cleaning unit 9.

Intermediate transfer rollers 6, intermediate transfer belt drive roller 71, intermediate transfer belt driven roller 72 and intermediate transfer belt tensioning mechanism 73 support and tension intermediate transfer belt 7 to circulatively drive intermediate transfer belt 7 in the direction of an arrow B in FIG. 1.

Intermediate transfer rollers 6 are rotatably supported at intermediate transfer roller fitting portions in intermediate transfer belt tensioning mechanism 73. Applied to each intermediate transfer roller 6 is a transfer bias for transferring the toner image from photoreceptor drum 3 to intermediate transfer belt 7.

Intermediate transfer belt 7 is arranged so as to be in contact with each photoreceptor drum 3. The toner images of different color components formed on photoreceptor drums 3 are successively transferred one over another to intermediate transfer belt 7 so as to form a full-color toner image (multi-color toner image). This intermediate transfer belt 7 is formed of an endless film of about 100 to 150 μm thick, for instance.

Transfer of the toner image from photoreceptor drum 3 to intermediate transfer belt 7 is effected by intermediate transfer roller 6 which is put in contact with the interior side of intermediate transfer belt 7. A high-voltage transfer bias (a high voltage of a polarity (+) opposite to the polarity (−) of the electrostatic charge on the toner) is applied to each intermediate transfer roller 6 in order to transfer the toner image.

Intermediate transfer roller 6 is composed of a shaft formed of metal (e.g., stainless steel) having a diameter of 8 to 10 mm and a conductive elastic material (e.g., EPDM, foamed urethane, etc.,) coated on the shaft surface. Use of this conductive elastic material enables intermediate transfer roller 6 to uniformly apply high voltage to intermediate transfer belt 7. Though in the present embodiment, roller-shaped elements (intermediate transfer rollers 6) are used as the transfer electrodes, brushes etc. can also be used in place.

The electrostatic latent image formed on each of photoreceptor drums 3 is developed as described above with the toner associated with its color component into a visual toner image. These toner images are laminated on intermediate transfer belt 7, laying one image over another. The thus formed lamination of toner images is conveyed by rotation of intermediate transfer belt 7 to the contact position (transfer position) between the conveyed paper and intermediate transfer belt 7, and is transferred to the paper by a transfer roller 11 arranged at that position. In this case, intermediate transfer belt 7 and transfer roller 11 are pressed against each other forming a predetermined nip while a voltage for transferring the toner image to the paper is applied to transfer roller 11. This voltage is a high voltage of a polarity (+) opposite to the polarity (−) of the electrostatic charge on the toner.

In order to keep the aforementioned nip constant, either transfer roller 11 or intermediate transfer belt drive roller 71 is formed of a hard material such as metal or the like while the other is formed of a soft material such as an elastic roller or the like (elastic rubber roller, foamed resin roller etc.).

Of the toner adhering to intermediate transfer belt 7 as the belt comes into contact with photoreceptor drums 3, the toner which has not been transferred from intermediate transfer belt 7 to the paper during transfer of the toner image and remains on intermediate transfer belt 7 would cause contamination of color toners at the next operation, hence is removed and collected by intermediate transfer belt cleaning unit 9.

Intermediate transfer belt cleaning unit 9 includes a cleaning blade (cleaning member) that is put in contact with intermediate transfer belt 7. Intermediate transfer belt 7 is supported from its interior side by intermediate transfer belt driven roller 72, at the area where this cleaning blade is put in contact with intermediate transfer belt 7.

Paper feed tray 10 is to stack sheets (e.g., recording paper) to be used for image forming and is disposed under the image forming portion and exposure unit 1. On the other hand, paper output tray 15 disposed at the top of image forming apparatus 100 stacks printed sheets facedown.

Image forming apparatus 100 also includes sheet conveyor system S for guiding sheets from paper feed tray 10 and from a manual feed tray 20 to paper output tray 15 by way of the transfer portion and fixing unit 12. Here, the transfer portion is located between intermediate transfer belt drive roller 71 and transfer roller 11.

Arranged along sheet conveyor system S are pickup rollers 16 (16a, 16b), a registration roller 14, the transfer portion, fixing unit 12 and feed rollers 25 (25a to 25h) and the like.

Feed rollers 25 are a plurality of small-diametric rollers arranged along sheet conveyor system S to promote and assist sheet conveyance. Pickup roller 16a is a roller disposed at the end of paper feed tray 10 for picking up and supplying the paper one sheet at a time from paper feed tray 10 to sheet conveyor system S. Pickup roller 16b is a roller disposed at the vicinity of manual feed tray 20 for picking up and supplying the paper, one sheet at a time, from manual feed tray 20 to sheet conveyor system S. Registration roller 14 temporarily suspends the sheet being conveyed on sheet conveyor system S and delivers the sheet to the transfer portion at such timing that the front end of the sheet meets the front end of the toner image on intermediate transfer belt 7.

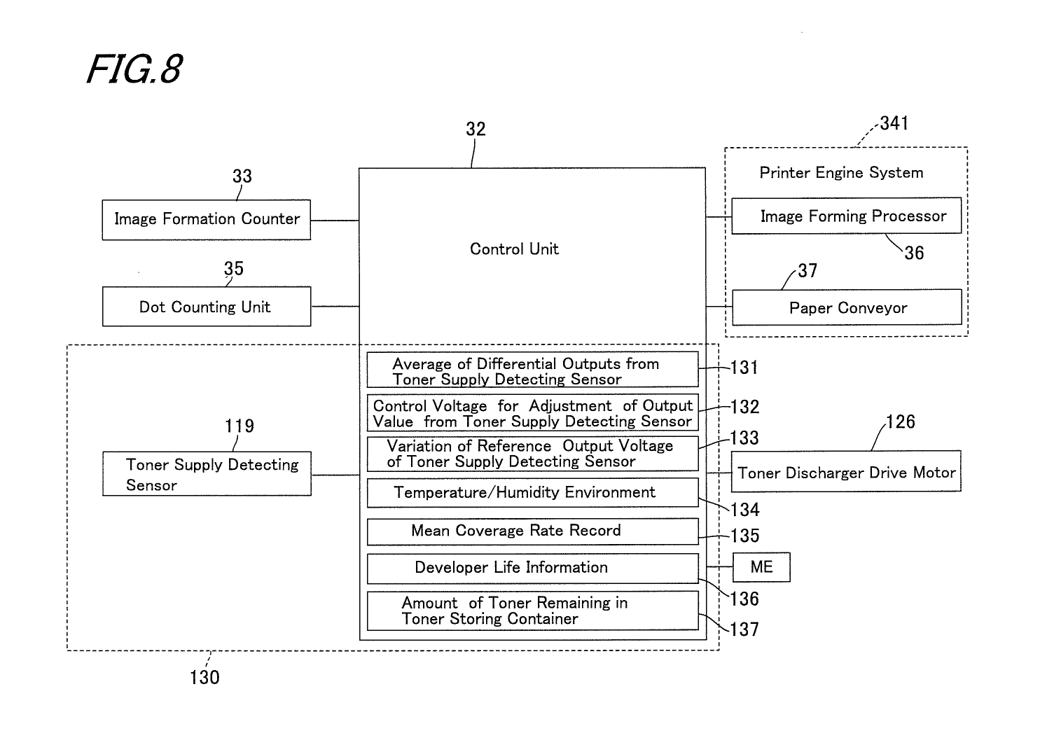

Fixing unit 12 includes a heat roller 81, a pressing roller 82 and the like. These heat roller 81 and pressing roller 82 rotate while nipping the sheet therebetween. Heat roller 81 is controlled by a controller 32 (FIG. 8) so as to keep a predetermined fixing temperature. This controller 32 controls the temperature of heat roller 81 based on the detection signal from a temperature detector (not shown).

Heat roller 81 fuses, mixes and presses the lamination of color toner images transferred on the sheet by thermally pressing the sheet with pressing roller 82 so as to thermally fix the toner onto the sheet. The sheet with a multi-color toner image (a single color toner image) fixed thereon is conveyed by plural feed rollers 25 to the inversion paper discharge path of sheet conveyor system S and discharged onto paper output tray 15 in an inverted position (with the multi-color toner image placed facedown).

Next, the operation of sheet conveyance by sheet conveyor system S will be described.

As shown in FIG. 1, image forming apparatus 100 has paper feed tray 10 that stacks sheets beforehand and manual feed tray 20 that is used when a few pages are printed out. Each tray is provided with pickup roller 16 (16a, 16b) so that these pickup rollers 16 supply the paper one sheet at a time to sheet conveyor system S.

In the case of one-sided printing, the sheet conveyed from paper feed tray 10 is conveyed by feed roller 25a in sheet conveyor system S to registration roller 14 and delivered to the transfer portion (the contact position between transfer roller 11 and intermediate transfer belt 7) by registration roller 14 at such timing that the front end of the sheet meets the front end of the image area including a lamination of toner images on intermediate transfer belt 7. At the transfer portion, the toner image is transferred onto the sheet. Then, this toner image is fixed onto the sheet by fixing unit 12. Thereafter, the sheet passes through a feed roller 25b to be discharged by a paper output roller 25c onto paper output tray 15.

Also, the sheet conveyed from manual feed tray 20 is conveyed by plural feed rollers 25 (25f, 25e and 25d) to registration roller 14. From this point, the sheet is conveyed and discharged to paper output tray 15 through the same path as that of the sheet fed from the aforementioned paper feed tray 10.

On the other hand, in the case of dual-sided printing, the sheet having been printed on the first side and passed through fixing unit 12 as described above is nipped at its rear end by paper discharge roller 25c. Then the paper discharge roller 25c is rotated in reverse so that the sheet is guided to feed rollers 25g and 25h, and conveyed again through registration roller 14 so that the sheet is printed on its rear side and then discharged to paper output tray 15.

Arranged near manual feed tray 20 is a hygrothermo sensor 90 so as to detect the temperature and humidity environment under which image forming apparatus 100 is used.

Next, the configuration of toner supply device 22 will be specifically described.

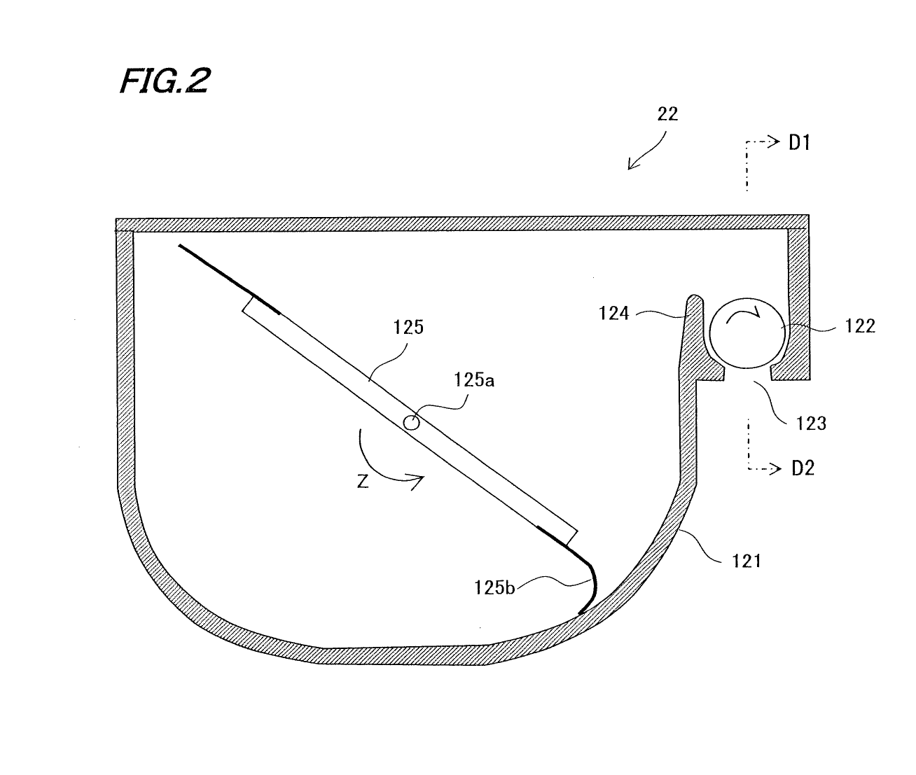

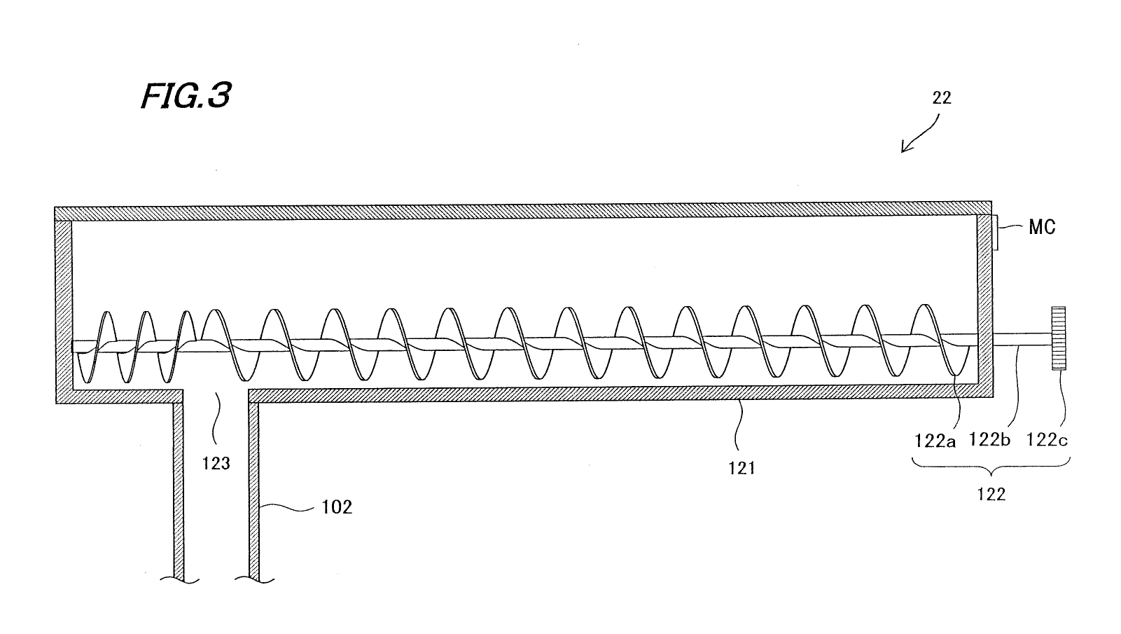

FIG. 2 is a sectional view showing a schematic configuration of the toner supply device that constitutes the image forming apparatus according to the present embodiment. FIG. 3 is a sectional view cut along a plane D1-D2 in FIG. 2.

As shown in FIGS. 2 and 3, toner supply device 22 includes a toner storing container 121, a toner agitator 125, a toner discharger 122 and a toner discharge port 123. Toner supply device 22 is arranged on the upper side of developing vessel 111 (FIG. 1) and stores unused toner (powdery toner). The toner in toner supply device 22 is supplied from toner discharge port 123 to developing vessel 111 (FIG. 1) by means of toner transport mechanism 102 (FIG. 1) as toner discharger (discharging screw) 122 is rotated.

Toner storing container 121 is a container part that has a substantially semicylindrical configuration with a hollow interior, supports toner agitator 125 and toner discharger 122 in a rotatable manner and stores toner. As shown in FIG. 3, toner discharge port 123 is a substantially rectangular opening disposed under toner discharger 122 and positioned near to the center with respect to the direction of the axis (the axial direction: longitudinal direction) of toner discharger 122 so as to oppose toner transport mechanism 102.

Toner agitator 125 is a plate-like part that rotates about a rotary axis 125a as shown in FIG. 2 and draws up and conveys the toner stored inside toner storing container 121 toward toner discharger 122 whilst agitating the toner. Toner agitator 125 has toner scooping parts 125b at both the ends thereof. Toner scooping part 125b is formed of a polyethylene terephthalate (PET) sheet having flexibility and is attached to either end of toner agitator 125.

Toner discharger 122 dispenses the toner in toner storing container 121 from toner discharge port 123 to developing vessel 111, and is formed of a screw auger having a toner conveyor blade 122a and a toner discharger rotary shaft 122b and a toner discharger rotating gear 122c, as shown in FIG. 3. Toner discharger 122 is rotationally driven by a toner discharger drive motor 126 (FIG. 8). As to the helix direction of the screw auger, the blade is formed so that toner can be conveyed from both ends of toner discharger 122 toward toner discharge port 123.

Provided between toner discharger 122 and toner agitator 125 is a toner discharger partitioning wall 124. This wall makes it possible to keep and hold the toner scooped by toner agitator 125 in an appropriate amount around toner discharger 122.

As shown in FIG. 2, when toner agitator 125 rotates in the direction of arrow Z to agitate and scoop up the toner toward toner agitator 122, toner scooping parts 125b rotate as they are deforming and sliding over the interior wall of toner storing container 121 due to the flexibility thereof, to thereby supply the toner toward the toner discharger 122 side. Then, toner discharger 122 turns so as to lead the supplied toner to toner discharge port 123.

Toner storing container 121 has a configuration that allows easy attachment and removal. At the time of toner empty, image forming apparatus 100 stops the printing job and displays a message, or turns on a lamp for recommendation of replacement of the toner container. When toner storing container 121 is replaced by a new one by the user, the printing job becomes able to be restarted and the message or the lamp for toner container replacement goes out. Toner storing container 121 has an IC memory chip MC (FIG. 3) attached thereto.

IC chip memory MC is attached to and removed from image forming apparatus 100 together with toner storing container 121 by the user. When the aforementioned toner discharger drive motor 126 (FIG. 8) is rotationally driven, the rotation time is recorded in IC memory chip of toner storing container 121. Image forming apparatus 100 calculates the data on the residual toner in toner storing container 121 from the total rotation time of the toner discharger drive motor and displays the amount of residual toner on a supply status window.

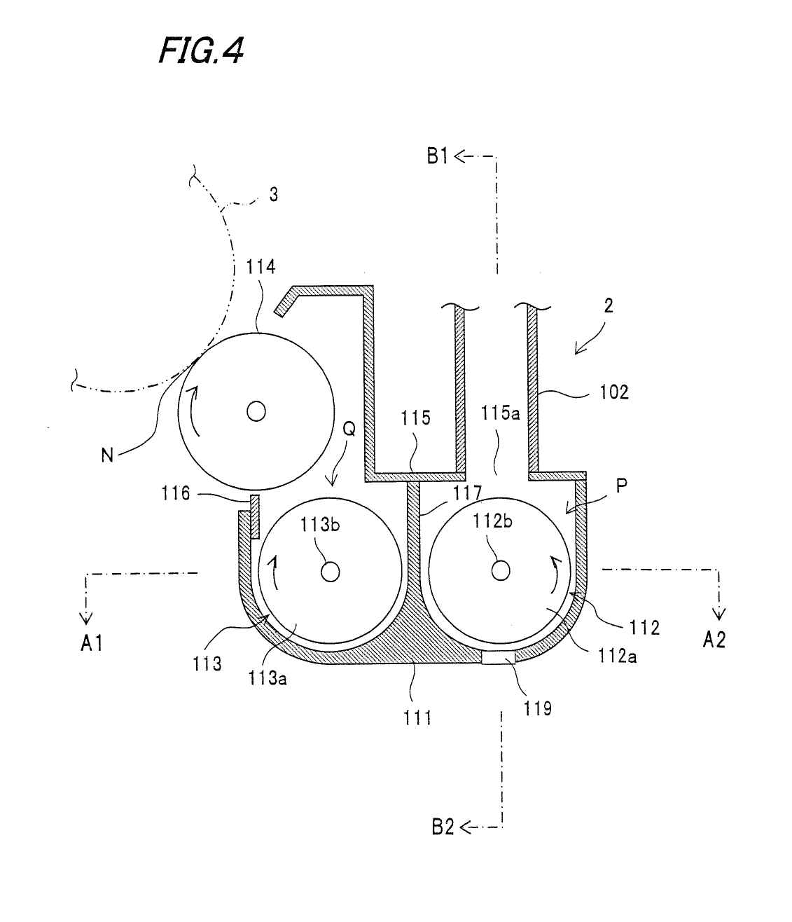

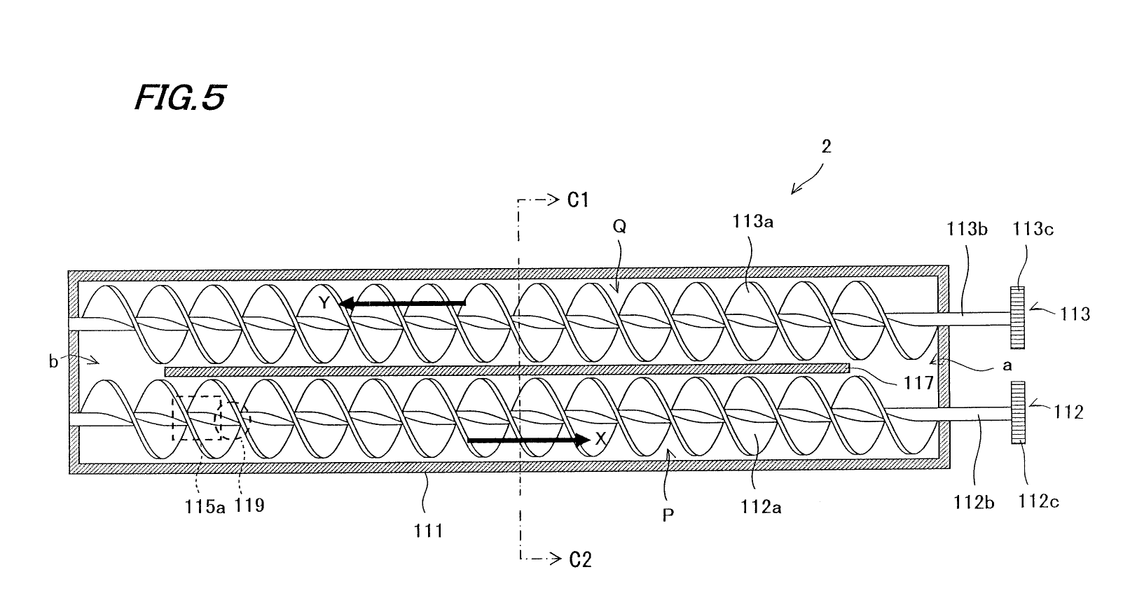

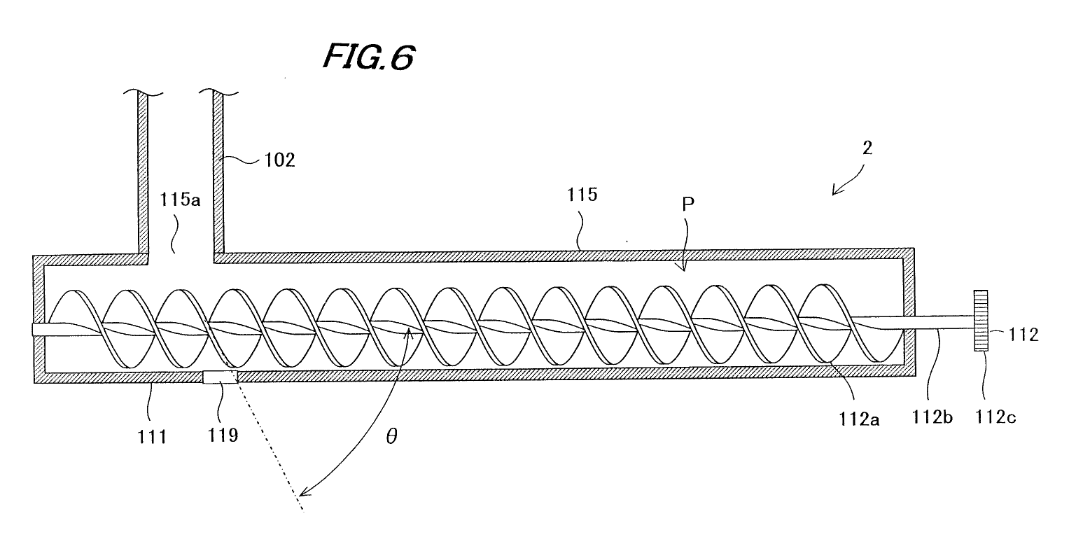

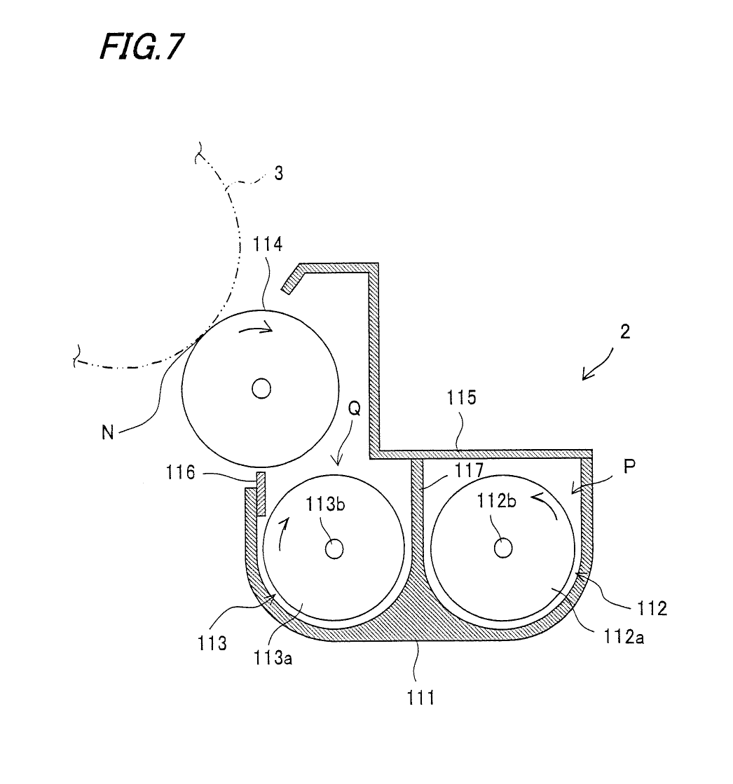

FIG. 4 is a sectional view showing the configuration of a developing device that constitutes the image forming apparatus according to the present embodiment, FIG. 5 is a sectional view cut along a plane A1-A2 in FIG. 4, FIG. 6 is a sectional view cut along a plane B1-B2 in FIG. 4, and FIG. 7 is a sectional view cut along a plane C1-C2 in FIG. 5.

Image forming apparatus 100 of the present embodiment includes: as shown in FIGS. 1 and 4, developing device 2 having a toner supply port 115a through which supplied toner is input into developing vessel (developer container) 111 for storing the developer; toner supply device 22 for supplying toner to developing device 2; a toner supply detecting sensor 119 for detecting whether toner is supplied into the developer container; and controller 32 that gives a command of supplying toner to developing device 2 to toner supply device 22 when the toner concentration of the developer in developing device 2 is lower than a predetermined level.

Controller 32 also functions as a toner empty determinater 130 (see FIG. 8) that determines that the toner in toner supply device 22 is used up when toner supply detecting sensor 119 does not detect any effect of toner supply after a toner supply command was given.

In image forming apparatus 100, toner supply detecting sensor 119 is arranged near toner supply port 115a and the toner empty determining threshold can be varied based on the output result from toner supply detecting sensor 119.

To begin with, developing device 2 will be described with reference to the drawings.

As shown in FIG. 4, developing device 2 has a developing roller (developer bearer) 114 arranged inside developing vessel 111 so as to oppose photoreceptor drum 3 and supplies toner from developing roller 114 to the photoreceptor drum 3 surface to visualize (develop) the electrostatic latent image formed on the surface of photoreceptor drum 3.

As shown in FIGS. 4 to 6, developing device 2 includes, other than developing roller 114, developing vessel 111, a developing vessel cover 115, toner supply port 115a, a doctor blade 116, a first conveying member 112, a second conveying member 113, a partitioning plate (partitioning wall) 117 and toner supply detecting sensor 119.

Developing vessel 111 is a container for holding a dual-component developer that contains a toner and a carrier (which will be simply referred to hereinbelow as “developer”). Developing vessel 111 includes developing roller 114, first conveying member 112, second conveying member 113 and the like. Here, the carrier of the present embodiment is a magnetic carrier presenting magnetism.

Arranged on the top of developing vessel 111 is removable developing vessel cover 115, as shown in FIGS. 4 and 6. This developing vessel cover 115 is formed with toner supply port 115a for supplying unused toner into developing vessel 111.

Arranged between first conveying member 112 and second conveying member 113 in developing vessel 111 is partitioning plate 117, as shown in FIGS. 4 and 5. Partitioning plate 117 is extended parallel to the axial direction (the direction in which each rotary axis is laid) of first and second conveying members 112 and 113. The interior of developing vessel 111 is divided by partitioning plate 117 into two sections, namely, a first conveying passage P with first conveying member 112 therein and a second conveying passage Q with second conveying member 113 therein.

Partitioning plate 117 is arranged so that its ends, with respect to the axial direction of first and second conveying members 112 and 113, are spaced from respective interior wall surfaces of developing vessel 111 (FIG. 5). Hereby, developing vessel 111 has communicating paths that establish communication between first conveying passage P and second conveying passage Q at around both axial ends of first and second conveying members 112 and 113. In the following description, as shown in FIG. 5, the communicating path formed on the downstream side with respect to the direction of arrow X is named first communicating path a and the communicating path formed on the downstream side with respect to the direction of arrow Y is named second communicating path b.

First conveying member 112 and second conveying member 113 are arranged so that their axes are parallel to each other with their peripheral sides opposing each other across partitioning plate 117, and are rotated in opposite directions. That is, as shown in FIG. 5, first conveying member 112 conveys the dual-component developer in the direction of arrow X while second conveying member 113 conveys the developer in the direction of arrow Y, which is the opposite to the direction of arrow X.

As shown in FIG. 5, first conveying member 112 is composed of a screw auger formed of a first helical conveying blade 112a and a first rotary shaft 112b, and a gear 112c. As shown in FIG. 5, second conveying member 113 is composed of a screw auger formed of a second helical conveying blade 113a and a second rotary shaft 113b, and a gear 113c. First and second conveying members 112 and 113 are rotationally driven by toner discharger drive motor 126 (FIG. 8) to agitate and convey the developer.

As shown in the sectional view of FIG. 6, first conveying member 112 is formed so that the angle formed between first rotary shaft 112b and the peripheral edge of first conveying blade 112a, or the inclined angle θ of the helical blade, falls within the range of 30 degrees to 60 degrees.

Specifically, when the inclined angle θ of the helical blade of first conveying member 112 is equal to or greater than 30 degrees and equal to or smaller than 60 degrees, the force of first conveying member 112 for agitating the developer in the rotational direction is so strong that the so-called “floating toner” phenomenon, the phenomenon of the supplied toner being conveyed floating over the developer, is unlikely to occur. Accordingly, it is possible for toner supply detecting sensor 119 to detect toner concentration of the developer with precision even after toner supply.

On the other hand, when the inclined angle θ of the helical blade is less than 30 degrees, the speed of the developer being conveyed by first conveying member 112 is low so that the developer is abraded quickly. When the inclined angle θ of the helical blade exceeds 60 degrees, the speed of the developer being conveyed by first conveying member 112 becomes so high that the floating toner phenomenon is prone to occur.

Developing roller 114 (FIG. 4) is a magnet roller which is rotationally driven about its axis by an unillustrated driver, and draws up and carries the developer in developing vessel 111 on the surface thereof to supply toner included in the developer supported on the surface thereof to photoreceptor drum 3.

The developer conveyed by developing roller 114 comes in contact with photoreceptor drum 3 in the area where the distance between developing roller 114 and photoreceptor drum 3 becomes minimum. This contact area is called a developing nip portion N (FIG. 4). Application of a developing bias to developing roller 114 from an unillustrated power source that is connected to developing roller 114 causes toner to transfer from the developer on the developing roller 114 surface to the electrostatic latent image on the photoreceptor drum 3 surface, in developing nip portion N.

Arranged close to the surface of developing roller 114 is a doctor blade (layer thickness limiting blade) 116.

Doctor blade 116 is a rectangular plate-shaped member that is extended parallel to the axial direction of developing roller 114, disposed vertically below developing roller 114 and supported along its longitudinal side by developing vessel 111 so that its opposite longitudinal side is spaced from the developing roller 114 surface. This doctor blade 116 may be made of stainless steel, or may be formed of aluminum, synthetic resin or the like.

Concerning the attachment of toner supply detecting sensor 119, with regard to the horizontal direction (developer conveying direction), the sensor is attached at a position near and on the downstream side of toner supply port 115a with respect to the developer conveying direction (the direction of arrow X) while with regard to the vertical direction, the sensor is attached on the base of developing vessel 111 vertically below first conveying member 112, as shown in FIGS. 4 to 6. That is, toner supply detecting sensor 119 is attached to the base of first conveying passage P with its sensor face exposed to the interior of developing vessel 111.

Toner supply detecting sensor 119 is electrically connected to controller 32 (FIG. 8). Toner supply detecting sensor 119 may use general-purpose detecting sensors. Examples include transmitted light detecting sensors, reflected light detecting sensors, magnetic permeability detecting sensors, etc. Of these, magnetic permeability detecting sensors are preferable.

The magnetic permeability detecting sensor is connected to an unillustrated power supply. This power supply applies to the magnetic permeability detecting sensor the drive voltage for driving the magnetic permeability detecting sensor and the control voltage for outputting the detected result of toner concentration to the control device. Application of voltage to the magnetic permeability detecting sensor from the power supply is controlled by the control device. The magnetic permeability detecting sensor is a sensor of a type that receives application of a control voltage and outputs the detected result of toner concentration as an output voltage. Basically, the sensor is sensitive in the middle range of the output voltage, so that the applied control voltage is adjusted so as to produce an output voltage around that range. Magnetic permeability detecting sensors of this kind are found on the market, examples including TS-L, TS-A and TS-K (all of these are trade names of products of TDK Corporation).

Now, conveyance of the developer in the developing vessel of developing device 2 will be described.

As shown in FIGS. 1 and 5, the toner stored in toner supply device 22 is transported into developing vessel 111 by way of toner transport mechanism 102 and toner supply port 115a, whereby toner is supplied to developing vessel 111.

In developing vessel 111, first conveying member 112 and second conveying member 113 are rotationally driven by toner discharger drive motor 126 (FIG. 8) to convey the developer. More specifically, in first conveying passage P, the developer is agitated and conveyed in the direction of arrow X by first conveying member 112 to reach first communicating path a. The developer reaching first communicating path a is conveyed through first communicating path a to second conveying passage Q.

On the other hand, in second conveying passage Q, the developer is agitated and conveyed in the direction of arrow Y by second conveying member 113 to reach second communicating path b. Then, the developer reaching second communicating path b is conveyed through second communicating path b to first conveying passage P.

That is, first conveying member 112 and second conveying member 113 agitate the developer while conveying it in opposite directions.

In this way, the developer is circulatively moving in developing vessel 111 along first conveying passage P, first communicating path a, second conveying passage Q and second communicating path b, in this mentioning order. In this arrangement, the developer is carried and drawn up by the surface of rotating developing roller 114 while being conveyed in second conveying passage Q, and the toner in the drawn up developer is continuously consumed as transferring to photoreceptor drum 3.

In order to compensate for this consumption of toner, unused toner is supplied from toner supply port 115a to the first conveying passage P. The thus supplied toner is agitated and mixed in first conveying passage P with the previously existing developer.

Next, the toner concentration control method (process) and toner empty determinater 130 in image forming apparatus 100 will be described in a detailed manner.

FIG. 8 is a block diagram showing a control system configuration in image forming apparatus 100.

The toner concentration control method may use a general method. For example, a control method using a toner concentration detecting sensor, a control method based on patch image density, a control method based on dot counting, and the like can be considered. Of these, the control method based on dot counting is preferable.

As shown in FIG. 8, image forming apparatus 100 includes a dot counting unit (dot counter) 35 for counting dots of data for image data to be transmitted to exposure unit 1.

Controller 32 for making toner concentration control instructs toner supply device 22 to supply toner to developing device 2 in accordance with the count of dots of data from dot counting unit 35.

If toner supply detecting sensor 119 does not detect any effect of toner supply after the toner supply command, control unit 32 determines that no toner has been supplied from toner supply device 22 to developing device 2, or that no toner remains in toner supply device 22 (toner empty).

Now, the control system of image forming apparatus 100 will be described based on a block diagram.

As shown in FIG. 8, image forming apparatus 100 includes an image formation counter 33 for counting the total number of image forming operations, dot counting unit 35 for detecting the total count of pixels of an image formed on photoreceptor drum 3, toner supply detecting sensor 119 for detecting the magnetic permeability of the developer near the toner supply port, a printer engine system 341 including an image forming processor 36 and a paper conveyor 37, a toner discharger drive motor 126 for driving toner discharger 122 that supplies toner to developing vessel 111 and control unit 32 for controlling these.

In image forming apparatus 100, toner concentration control is mainly carried out by means of dot counting unit 35, control unit 32 and toner discharger drive motor 126, as shown in FIG. 8.

Dot counting unit 35 is to detect the total number of pixels of images (electrostatic latent images) formed on photoreceptor drum 3 corresponding to the printed images, and stores the total count of the pixels of the images to be printed and the total count of the images that have been printed heretofore as a dot count value. The thus calculated dot count value is recorded into memory ME (FIG. 8) by control unit 32. From the dot count value, detected (calculated) by dot counting unit 35, the amount of toner consumed for image forming can be estimated.

Control unit 32 determines the amount of toner to be consumed for the current image forming based on the dot count value and controls rotational driving of toner discharger drive motor 126 in accordance with the determined amount of toner.

In this way, toner corresponding to the amount of toner consumed from developing device 2 (developing vessel 111) is supplied from toner supply device 22 into developing device 2 (developing vessel 111).

In image forming apparatus 100, toner empty determiner 130 is mainly configured of toner supply detecting sensor 119 and control unit 32, as shown in FIG. 8.

Control unit (toner empty determination controller) 32 includes: as shown in FIG. 8, a corrective function 131 for correcting the toner empty determining threshold based on the average of the differences of the output values from toner supply detecting sensor 119; a corrective function 132 for correcting the toner empty determining threshold based on the control voltage for adjusting and resetting the output value from toner supply detecting sensor 119 to the predetermined reference value; and a corrective function 133 for correcting the toner empty determining threshold based on the variation of the reference output value of toner supply detecting sensor 119. Corrective functions 131, 132 and 133 will be detailed later.

In the present embodiment, the toner concentration of the developer in developing vessel 111 is continuously monitored by toner supply detecting sensor 119, and if toner supply detecting sensor 119 has not detected any effect of toner supply even after a toner supply command was given from control unit 32 to toner supply device 22, control unit (toner empty determination controller) 32 determines the status of toner to be that of empty.

Next, toner supply to developing device 2 in image forming apparatus 100 of will be described.

Toner supply to developing device 2 in image forming apparatus 100 is performed from toner supply device 22 to developing device 2 by control unit 32, which directs toner supply device 22 to supply toner to developing device 2 when the toner concentration of the developer in developing vessel 111 of developing device 2 has lowered and becomes lower than a predetermined level.

Toner supply into developing vessel 111 is detected by toner supply detecting sensor 119. Since toner supply detecting sensor 119 is disposed on the base in the first conveying passage P under toner supply port 115a, if toner is added to the developer from toner supply port 115a, it is possible to promptly detect change of the magnetic permeability of the developer. That is, it is possible to immediately recognize whether or not toner supply from toner supply device 22 is performed.

Accordingly, if toner supply detecting sensor 119 does not detect any change of the magnetic permeability of the developer even after a toner supply command was given from control unit 32 to toner supply device 22, it is possible to determine that no toner supply from toner supply device 22 has been made. In other words, control unit 32 immediately determines that the toner in toner supply device 22 is used up (toner empty).

According to the present embodiment having the configuration described heretofore, since toner supply detecting sensor 119 is disposed in the vicinity of toner supply port 115a of developing device 2 and on the bottom of first conveying passage P under toner supply port 115a, it is possible to promptly detect a change of the magnetic permeability when toner is supplied from toner supply device 22.

Accordingly, in a case where toner supply detecting sensor 119 has detected no change in magnetic permeability when the toner concentration of the developer inside developing device 2 had become lower than the predetermined level and the toner concentration controller directed toner supply device 22 to supply toner, control unit 32 immediately determines that the toner in toner supply device 22 is used up (toner empty). As a result, it is possible to prevent the occurrence of carrier adherence to photoreceptor drum 3 due to a decrease in toner concentration when a toner image is formed on photoreceptor drum 3.

Further, since first conveying member 112 is constructed so that the inclined angle θ of the helical blade falls within the range from 30 degrees to 60 degrees, the force of agitating the developer in the rotational direction of first conveying member 112 becomes strong so that the so-called “floating toner” phenomenon, the phenomenon of the added toner being conveyed floating over the developer, is unlikely to occur. Accordingly, it is possible for toner supply detecting sensor 119 to detect change in magnetic permeability of the developer with precision even after toner supply to developing device 2.

Next, how to determine the toner empty timing of toner supply device 22 will be specifically described with reference to the drawings.

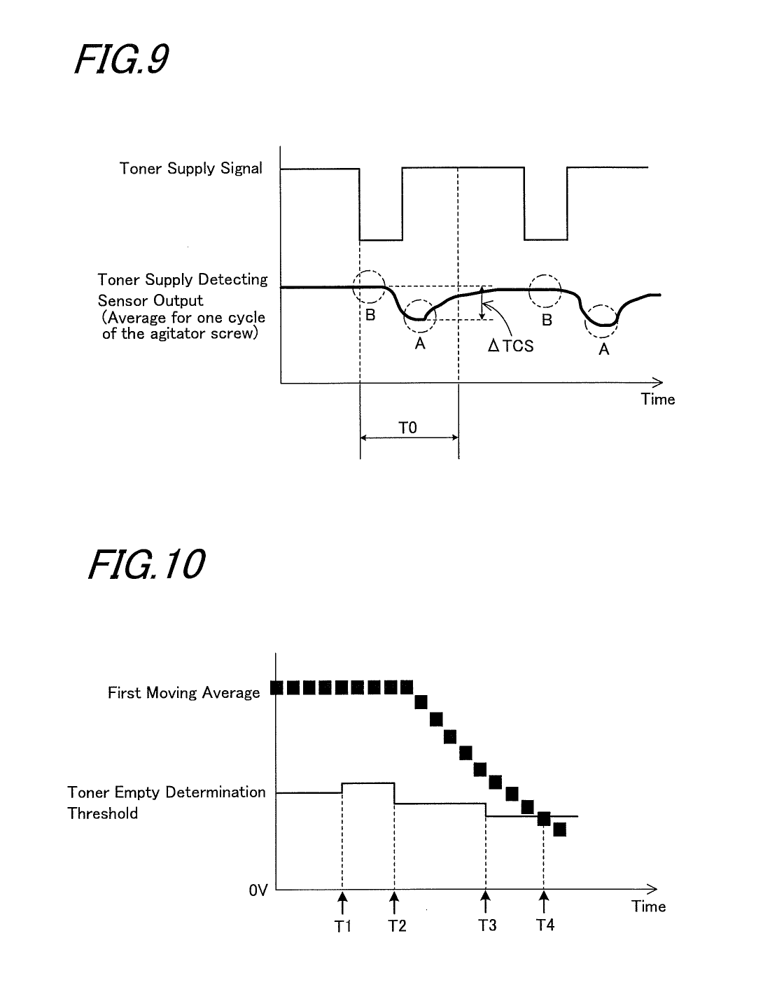

FIG. 9 is a graph showing the relationship between a toner supply signal indicating a toner supply from the toner supply device and the output from a toner supply detecting sensor. FIG. 10 is a graph showing temporal change of the difference between the output values from toner supply detecting sensor before and after a toner supply from the toner supply device and corresponding change (modification) of the toner empty determining threshold.

In image forming apparatus 100, the toner empty timing of toner supply device 22 is determined based on the change in magnetic permeability detected by toner supply detecting sensor 119 before and after a toner supply at the timing of supplying toner from toner supply device 22 and the toner empty determining threshold that is corrected based on the change in magnetic permeability and other factors.

Specifically, the output value from toner supply detecting sensor 119 is continuously monitored as its average in one cycle of first helical conveying blade 112a, as shown in FIG. 9.

Then, immediately after a command (toner supply signal) is given to toner discharger drive motor 126 so as to cause discharger 122 of toner supply device 22 to rotate, the average output value from toner supply detecting sensor 119 is sampled for a predetermined period of time T0.

In FIG. 9, T0 represents the sampling time for detecting toner concentration by toner supply detecting sensor 119. In the toner supply signal shown in the upper part of FIG. 9, the high level represents the OFF state while the low level represents the ON state.

The maximum and minimum values of the sampling data by toner supply detecting sensor 119 in sampling time T0 are denoted as B and A, respectively, and the difference Δ(B−A) (which will be called “ΔTCS” hereinbelow) between the sensor output values before and after a toner supply is calculated.

That is, since there is a time lag from the start of toner supply based on the generation of the toner supply signal up to detection of toner supply by toner supply detecting sensor 119, the maximum value B is a sensor output value before a toner supply and the minimum value A is a sensor output value after the toner supply. Accordingly, it is necessary to select such a sampling time T0 as to be able to detect both the maximum value B and the minimum value A, taking the time lag into consideration.

Every time toner discharger drive motor 126 starts operating, ΔTCS is calculated and stored based on the varying output values from toner supply detecting sensor 119 before and after the toner supply, and the average of the latest M ΔTCS values is calculated (which will be referred to hereinbelow as “the first moving average”.

Further, in the present embodiment, the toner empty determining threshold is varied based on the result of image quality control (process control), the average of the latest N ΔTCS values (which will be referred to hereinbelow as “the second moving average”, and other factors, as shown in FIG. 10.

Times T1, T2 and T3 in FIG. 10 are the timings at which the toner empty determining threshold is modified. Time T1 corresponds to a state where a high enough amount of toner is supplied from toner supply device 22; time T2 a state where the supplied amount of toner has become low; and time T3 a state where the supplied amount of toner has become considerably low.

When the first moving average becomes lower than the toner empty determining threshold (in the state at time T4), the supplied amount of toner is determined to reach a sufficiently low level so that a toner empty determination is made.

Now, the method of modifying the toner empty determining threshold will be described specifically.

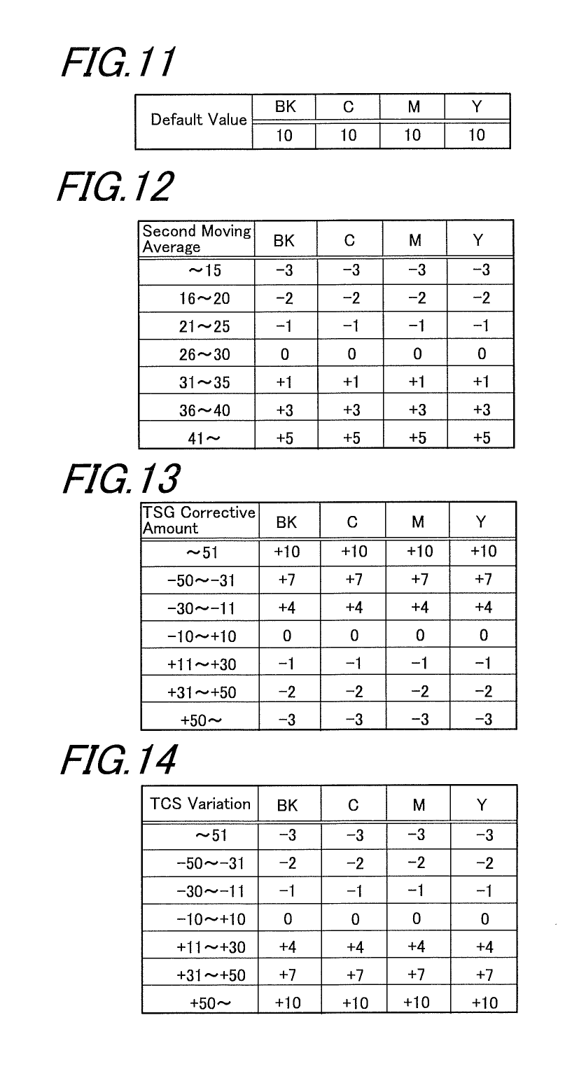

In the present embodiment, tables given in FIGS. 11 to 20 have been stored in advance in memory ME (FIG. 8) in image forming apparatus 100, and the toner empty determining threshold after modification is also stored.

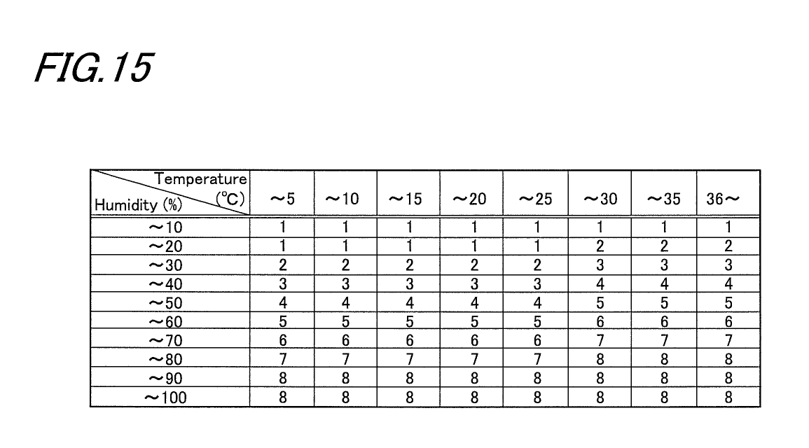

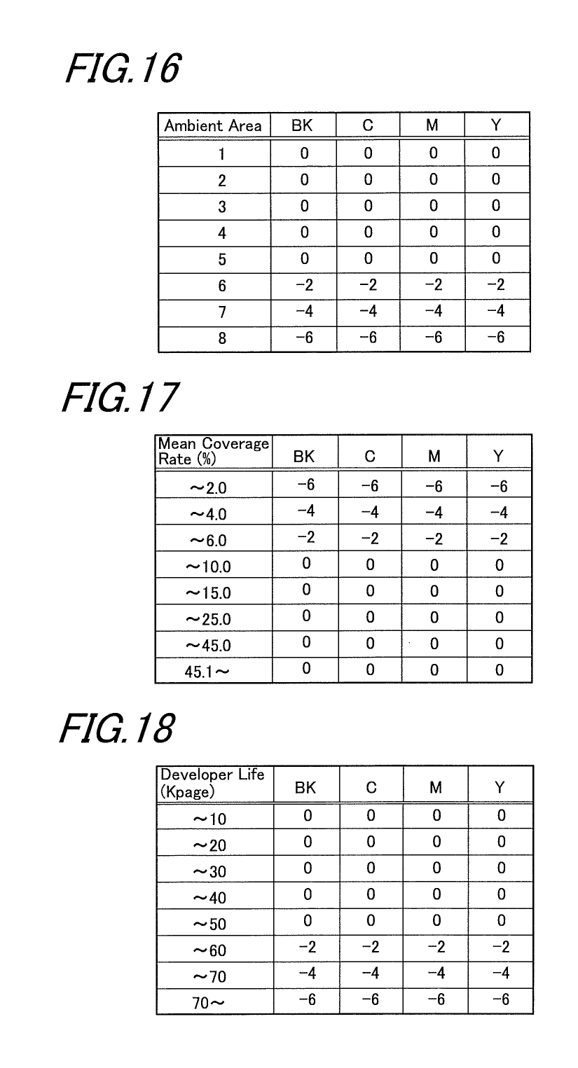

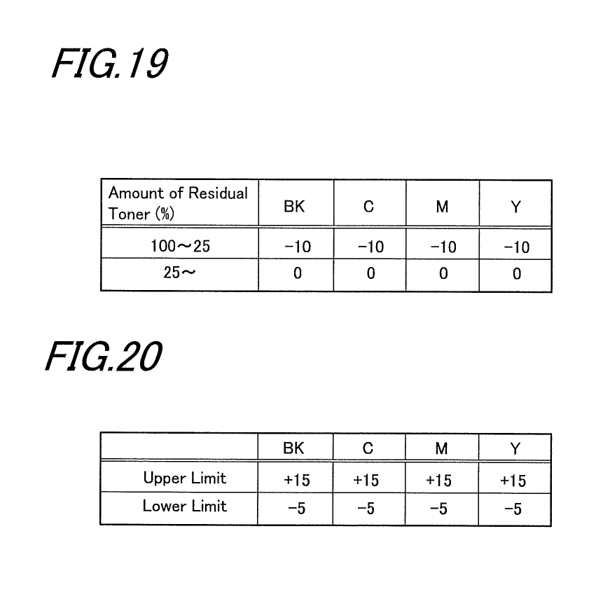

FIG. 11 is a table for setting a default value of the toner empty determining threshold for each color in the image forming apparatus of the present embodiment. FIG. 12 is a table for presenting corrective values in accordance with change in the sensor sensitivity of the toner supply detecting sensor with the passage of time. FIG. 13 is a table for presenting corrective values in accordance with the amount of correction of the control voltage at the time of image quality control in the image forming apparatus. FIG. 14 is a table for presenting corrective values in accordance with the difference (variation) of the output values of the toner supply detecting sensor before and after a toner supply at the time of supplying toner in the image forming apparatus. FIG. 15 is a table for presenting ambient area classes depending on temperature and humidity. FIG. 16 is a table for presenting corrective values in accordance with the class of the ambient area in which the image forming apparatus is used. FIG. 17 is a table for presenting corrective values in accordance with the record of the mean coverage rate of printout operation. FIG. 18 is a table for presenting corrective values in accordance with the life information of the developer. FIG. 19 is a table for presenting corrective values in accordance with the amount of toner remaining in toner storing container. FIG. 20 is a table for presenting the upper and lower limits of the total corrective value of the toner empty determining threshold for each color in the image forming apparatus.

As shown in FIG. 8, control unit (toner empty determination controller) 32 performs corrective function 131 of correcting the toner empty determining threshold based on the average of the differential output of the toner supply detecting sensor, corrective function 132 of correcting the toner empty determining threshold based on the control voltage (TSG) for adjusting and restoring the output value from the toner supply detecting sensor to the reference value; corrective function 133 of correcting the toner empty determining threshold based on the variation of the reference output value of toner supply detecting sensor 119, a corrective function 134 of correcting the toner empty determining threshold based on the temperature and humidity environment, a corrective function 135 of correcting the toner empty determining threshold based on the mean coverage rate record of printout operation, a corrective function 136 of correcting the toner empty determining threshold based on the life information of the developer and a corrective function 137 of correcting the toner empty determining threshold based on the amount of toner remaining in the toner storing container.

In order to implement correcting functions 131 to 137, control unit 32 uses the table for setting the default values of the thresholds for toner empty determination and table for their correction, as shown in FIGS. 11 to 19.

In the tables shown in FIGS. 11 to 19, the default value and various kinds of corrective values are designated based on the standard that 3.3 V, the maximum output value from toner supply detecting sensor 119 is set at 256, for example. However, the present invention should not be limited by the method of determining the standard and the numerical values.

To begin with, the default value (initial set value) of the toner empty determining threshold for toner supply device 22 of each color is set at 10 for all of BK (black), C (cyan), M (magenta) and Y (yellow).

The toner empty determining threshold is corrected in accordance with the table of FIG. 12 based on the second moving average, depending on the change of the sensor sensitivity of toner supply detecting sensor 119 with the passage of time.

Specifically, as shown in FIG. 12, for all of BK (black), C (cyan), M (magenta) and Y (yellow), the corrective value is set at “−3” when the second moving average is “equal to or smaller than 15”, the corrective value is set at “−2” when the second moving average ranges from “16 to 20”, the corrective value is set at “−1” when the second moving average ranges from “21 to 25”, the corrective value is set at “0” when the second moving average ranges from “26 to 30”, the corrective value is set at “+1” when the second moving average ranges from “31 to 35”, the corrective value is set at “+3” when the second moving average ranges from “36 to 40”, and the corrective value is set at “+5” when the second moving average is “equal to or greater than 41”.

That is, in order to modify the toner empty determining threshold for each color, a corrective value in accordance with the second moving average as the average of N (N>M) ΔTCSs is acquired from the table shown in FIG. 12.

Specifically, it is determined that the sensor sensitivity of toner supply detecting sensor 119 has become low when the second moving average is small, and the toner empty determining threshold is made smaller. On the other hand, it is determined that the sensor sensitivity of toner supply detecting sensor 119 has become high when the second moving average is large, and the toner empty determining threshold is made greater.

Here, in the present embodiment, M for calculation for the first moving average is designated at 10 and N for calculation for the second moving average is designated at 30. In order to deal with occasional fluctuation of ΔTCS depending on the condition of the developer and perform correct detection of empty timing, N is designated to be greater than M (N>M). However, the present invention should not be limited to the above numbers. Further, though it is preferable that N>M, it goes without saying that it is possible to designate N equal to M so as to improve processing efficiency.

Also, based on the table shown in FIG. 13, the toner empty determining threshold is modified in accordance with the amount of correction of the control voltage at the time of image quality control in image forming apparatus 100. The image quality control is adjustment for image quality change etc. of the output image, such as change in print image density, change in color.

Specifically, as shown in FIG. 13, for all of BK (black), C (cyan), M (magenta) and Y (yellow), the corrective value is set at “+10” when the corrective value for the control voltage (TSG) is “equal to or lower than −51”, the corrective value is set at “+7” when the corrective value for the control voltage ranges from “−50 to −31”, the corrective value is set at “+4” when the corrective value for the control voltage ranges from “−30 to −11”, the corrective value is set at “0” when the corrective value for the control voltage ranges from “−10 to +10”, the corrective value is set at “−1” when the corrective value for the control voltage ranges from “+11 to +30”, the corrective value is set at “−2” when the corrective value for the control voltage ranges from “+31 to +50”, and the corrective value is set at “−3” when the corrective value for the control voltage is “equal to or greater than +51”.

That is, the control voltage is adjusted so as to restore the sensor output value from toner supply detecting sensor 119 to the reference value (128), at the time of image quality control (process control) in image forming apparatus 100. Then, the corrective value for the toner empty determining threshold in accordance with the corrective value for the control voltage at the time of image quality control (the amount of correction of the control voltage) is acquired from the table shown in FIG. 13. Here, the aforementioned reference value, 128 is also taken based on the standard that 3.3 V, the maximum output value from toner supply detecting sensor 119 is set at 256. However, the present invention should not be limited to this.

In this case, when the control voltage at the time of image quality control is corrected to the positive side, it is determined that the sensor sensitivity has become low due to increase in toner concentration, and the toner empty determining threshold is made smaller. On the contrary, when the control voltage at the time of image quality control is corrected to the negative side, it is determined that the sensor sensitivity has become high due to decrease in toner concentration, and the toner empty determining threshold is made greater.

Also, based on the table shown in FIG. 14, the toner empty determining threshold is modified in accordance with the difference of the output values from toner supply detecting sensor 119 before and after the toner supply at the time of supplying toner in image forming apparatus 100 (the TCS variation: TCS maximum (point B in FIG. 9)−TCS reference value (128)).

Specifically, as shown in FIG. 14, for all of BK (black), C (cyan), M (magenta) and Y (yellow), the corrective value is set at “−3” when the TCS variation is “equal to or lower than −51”, the corrective value is set at “−2” when the TCS variation ranges from “−50 to −31”, the corrective value is set at “−1” when the TCS variation ranges from “−30 to −11”, the corrective value is set at “0” when the TCS variation ranges from “−10 to +10”, the corrective value is set at “+4” when the TCS variation ranges from “+11 to +30”, the corrective value is set at “+7” when the TCS variation ranges from “+31 to +50”, and the corrective value is set at “+10” when the TCS variation is “equal to or greater than +51”.

That is, the TCS variation is calculated by subtracting the TCS reference value (128) from the TCS maximum (the B value in the drawing) when ΔTCS, the difference before and after toner supply at the time of supplying toner in image forming apparatus 100, is calculated. Then, the corrective value for the toner empty determining threshold in accordance with the TCS variation at the time of toner supply is acquired from the table shown in FIG. 14.

When the TCS variation is negative, it is determined that the sensor sensitivity has become low due to increase in toner concentration, and the toner empty determining threshold is made smaller. On the contrary, when the TCS variation is positive, it is determined that the sensor sensitivity has become high due to decrease in toner concentration, and the toner empty determining threshold is made greater.

Here, the aforementioned TCS reference value, 128 is also taken based on the standard that 3.3 V, the maximum output value from toner supply detecting sensor 119 is set at 256. However, the present invention should not be limited to this.

Further, image forming apparatus 100 calculates the ambient area class in accordance with the temperature and humidity data detected by hygrothermo sensor 90, based on the table shown in FIG. 15. The toner empty determining threshold is modified in accordance with the ambient area class, based on the table shown in FIG. 16.

Specifically, as shown in FIG. 16, for all of BK (black), C (cyan), M (magenta) and Y (yellow), the corrective value is set at “−6” when the ambient area class is “8”, the corrective value is set at “−4” when the ambient area class is “7”, the corrective value is set at “−2” when the ambient area class is “6”, and the corrective value is set at “0” when the ambient area is “5”.

Correction based on the above ambient area class is performed taking into account that when the ambient area class is “equal to or greater than 6”, i.e., under a high-temperature and high-humidity environment, the fluidity of the developer lowers so that it takes long time for the supplied toner to reach toner supply detecting sensor 119 and ΔTCS tends to be smaller compared to that under a low-temperature low-humidity environment.

Image forming apparatus 100 also calculates the mean coverage rate information from the dot count of printout operation for the last L pages. The toner empty determining threshold is modified in accordance with the mean coverage rate information of printout operation, based on the table shown in FIG. 17.

Specifically, as shown in FIG. 17, for all of BK (black), C (cyan), M (magenta) and Y (yellow), the corrective value is set at “−6” when the mean coverage rate of the last L pages of printout is “equal to or lower than 2.0”, the corrective value is set at “−4” when the mean coverage rate of the last L pages of printout ranges from “2.0 to 4.0”, the corrective value is set at “−2” when the mean coverage rate of the last L pages of printout ranges from “4.0 to 6.0”, and the corrective value is set at “0” when the mean coverage rate of the last L pages of printout is “equal to or greater than 6.0”. The numeric values of the mean coverage rate are merely given as an example, and the invention should not be limited to this. The way of representation of mean coverage rate can be arbitrarily determined.

Correction based on the above mean coverage rate information is performed taking into account that when the mean coverage rate of the last L pages of printout is “equal to or lower than 6.0”, i.e., during a low-coverage printing job, the toner in the developer is unlikely to be replaced so that the fluidity of the developer lowers and ΔTCS tends to be smaller compared to that during a high-coverage printing job.

Further, the toner empty determining threshold is modified in accordance with the developer life information, based on the table shown in FIG. 18.

Specifically, as shown in FIG. 18, for all of BK (black), C (cyan), M (magenta) and Y (yellow), the corrective value is set at “0” when the developer life (the number of pages having been printed out from when the developer was fresh up to the present) is “50K (K=1,000) or below”, the corrective value is set at “−2” when the developer life ranges from “50K to 60K”, the corrective value is set at “−4” when the developer life ranges from “60K to 70K”, and the corrective value is set at “−6” when the developer life exceeds “70K”. The figures of the above life are given as an example, and the present invention should not be limited to this.

The above correction is performed by taking into account that when the developer life exceeds “50K”, or in the second half of the developer life, the fluidity of the developer lowers due to separation of the coated resin from the surface of the carrier in the developer or due to fusion and adherence of toner to the carrier surface, so that ΔTCS tends to be low compared to that in the first half of the developer life.

Also, based on the table shown in FIG. 19, the toner empty determining threshold is modified in accordance with the amount of toner remaining in the toner storing container.

Specifically, as shown in FIG. 19, for all of BK (black), C (cyan), M (magenta) and Y (yellow), the corrective value is set at “0” when the amount of residual toner (the data calculated from the total toner supply time stored in the aforementioned IC chip) is “less than 25%”, and the corrective value is set at “−10” when the amount of residual toner is “equal to or greater than 25%”. However, the above values of the amount of residual toner are given as an example, and the invention should not be limited to this.

That is, image forming apparatus 100 calculates the amount of residual toner from the total rotation time of toner discharger drive motor 126 stored in IC memory chip MC (FIG. 3) of toner storing container 121 for each of the replaceable toner storing containers 121. When the calculated amount of residual toner is “less than 25%”, there is a chance of toner empty, whereas there is little chance of toner empty when the calculation is “equal to or greater than 25%”. So, the toner empty determining threshold is made smaller when it is “equal to or greater than 25%”.

Further, for the toner empty determining threshold for each color in image forming apparatus 100, the corrective value to the toner empty determining threshold is restricted by the upper and lower limits, based on the table shown in FIG. 20.

Specifically, as shown in FIG. 20, for all of BK (black), C (cyan), M (magenta) and Y (yellow), the corrective value is limited within the range from the lower limit of “−5” to the upper limit of “+15”.

That is, in the present embodiment, in order to prevent over-correction of the toner empty determining threshold, the sum of: (1) the corrective value in accordance with the change of the sensor sensitivity of toner supply detecting sensor 119; (2) the corrective value in accordance with the amount of correction of the control voltage at the time of image quality control; (3) the corrective value in accordance with the variation of the output value from toner supply detecting sensor 119; (4) the corrective value in accordance with the temperature and humidity environment; (5) the corrective value in accordance with the mean coverage rate information of printout operation; (6) the corrective value in accordance with the developer life information; and (7) the corrective value in accordance with the amount of residual toner, as the tonal corrective value, is restricted by the upper and lower limits.

In the present embodiment, based on the values of the tables stated above, the toner empty determining threshold is calculated by the following calculation formula (a);

The toner empty determining threshold=the default value+(1)+(2)+(3)+(4)+(5)+(6)+(7) (a).

With the above arrangement, when the first moving average (the average of the last M ΔTCSs) detected by toner supply detecting sensor 119 becomes lower than the toner empty determining threshold, the occurrence of toner empty is determined.

In the above way, changing the toner empty determining threshold in accordance with the change of the sensor sensitivity of toner supply detecting sensor 119 depending on the condition of the developer, the amount of correction of the control voltage at the time of image quality control, the variation of the output value from toner supply detecting sensor 119, the temperature and humidity environment, the mean coverage rate information of printout operation, the developer life information and the amount of toner remaining in the toner storing container, makes it possible to deal with occasional fluctuation of ΔTCS depending on the condition of the developer and perform exact detection of a toner empty timing.

As a result, it is possible to perform stable toner supply without causing too early indication of toner empty despite a large amount of toner remaining or without causing shortage of toner due to too late toner empty detection, it is hence possible to provide an image forming apparatus that can stably produce high-quality images.

Further, in order to change the toner empty determining threshold in accordance with the average of the differential outputs of the toner supply detecting sensor, the control voltage for adjusting and restoring the output value from the toner supply detecting sensor to the reference value, the variation of the reference output value from toner supply detecting sensor 119, the temperature and humidity environment, the mean coverage rate information of printout operation, the developer life information and the amount of toner remaining in the toner storing container, individual associated tables are used, so that it is possible to perform correction processes easily, based on the output from the toner supply detecting sensor and the like.

Moreover, since the amount of correction to the toner empty determining threshold is limited by the upper and lower limits, it is possible to prevent over-correction of the toner empty determining threshold and achieve stable toner empty determination without causing a large error.

Though, in the present embodiment, in order to correct (modify) the toner empty determining threshold, the corrective values (1) to (7), shown in FIGS. 12 to 14 and FIGS. 16 to 19, are used, it goes without saying that any one or combination of the corrective values selected from (1) to (7) may be used depending on the devices and functions provided for the image forming apparatus on which toner empty determination is performed.

The above embodiment was described taking an example in which the image forming apparatus of the present invention is applied to image forming apparatus 100 shown in FIG. 1. However, as long as it is an image forming apparatus in which the toner concentration of the developer in the developing device is controlled by supplying toner from a toner supply device, the invention can be developed to any other image forming apparatus and the like, not limited to the image forming apparatus and copier described above.

Having described heretofore, the present invention is not limited to the above embodiment, various changes can be made within the scope of the appended claims. That is, any embodied mode obtained by combination of technical means modified as appropriate without departing from the spirit and scope of the present invention should be included in the technical art of the present invention.

What is claimed is:

1. An image forming apparatus comprising:
a developing device;
a toner supply device;
a toner supply detecting sensor; and,
a toner empty determination controller, characterized in that
the developing device comprises:
a developer container for storing a developer including a toner and a magnetic carrier;
a developer conveying structure disposed inside the developer container for circulatively conveying the developer whilst agitating;
a developing roller for supplying the toner included in the developer to a photoreceptor drum; and,
a toner supply port that leads supplied toner into the developer container,
the toner supply device supplies the toner into the developing device,
the toner supply detecting sensor detects whether the toner has been supplied into the developer container,
the toner empty determination controller instructs the toner supply device to supply toner to the developing device when the toner concentration of the developer in the developing device has become lower than a predetermined level,
the toner empty determination controller determines that the toner in the toner supply device is used up when no toner supply is detected by the toner supply detecting sensor after the instruction of toner supply by the controller, and,
the toner empty determination controller, based on the output result from the toner supply detecting sensor, corrects the toner empty determining threshold based on which toner empty is determined.

2. The image forming apparatus according to claim 1, wherein the toner empty determination controller performs the correction, based on, at least, any one of,
the average of the differences between the detected values output from the toner supply detecting sensor before and after toner supply at the time of supplying toner,
the control voltage correction result of the toner supply detecting sensor at the time of image quality control, and
the deviation of the output value of the toner supply detecting sensor, from the reference value.

3. The image forming apparatus according to claim 1 or 2, wherein the toner empty determination controller performs the correction, based on, at least, any one of,
the temperature and humidity environment under which the image forming apparatus is used,
the mean coverage rate information of printout operation, and
the life information of the developer.

4. The image forming apparatus according to claim 1 or 2, wherein the toner empty determination controller performs the correction, based on the amount of toner remaining in a replaceable toner storing container.

5. The image forming apparatus according to claim 3, wherein the toner empty determination controller performs the correction, based on the amount of toner remaining in a replaceable toner storing container.

6. The image forming apparatus according to claim 1, wherein the toner supply detecting sensor is disposed near the toner supply port in the developer container.

7. The image forming apparatus according to claim 1, wherein the toner supply detecting sensor detects the magnetic permeability of the developer in the developer container.

8. The image forming apparatus according to claim 1, wherein the developing device includes: a first conveying passage and a second conveying passage that are sectioned by a partitioning wall and arranged to communicate with each other at both ends of the partitioning wall; and,
a first conveying member and a second conveying member that are arranged as the developer conveying structure in the first conveying passage and second conveying passage, respectively, agitate and circulatively convey the developer in the first conveying passage and in the second conveying passage, in opposite directions to each other,
the developing device supplies the developer inside the second conveying passage to the photoreceptor drum by means of the developing roller,
the toner supply port is disposed over the first conveying passage, and,
the toner supply detecting sensor is disposed at the bottom of the first conveying passage under the toner supply port.

9. The image forming apparatus according to claim 8, wherein the first conveying member is a screw auger having a rotary shaft and a helical blade, and the helical blade is formed so that the inclined angle relative to the axial direction of the rotary shaft is specified to fall within the range of 30 degrees to 60 degrees.

10. The image forming apparatus according to claim 1, further comprising a dot counter for counting dots of data corresponding to image data to be transmitted to the exposure device for forming an electrostatic latent image on the photoreceptor drum surface,
wherein the toner empty determination controller instructs the toner supply device to supply toner to the developing device based on the count of the dots of data from the dot counter.
